(19) United States
(12) Patent Application Publication
(10) Pub. No.: US 2022/0309930 A1
(43) Pub. Date: Sep. 29, 2022

(54) DEVICE FOR ASSISTING IN THE PILOTING OF AIRCRAFT

(71) Applicant: THALES, Courbevoie (FR)

(72) Inventors: Laurent FLOTTE, TOULOUSE (FR); Sylvain YAN, TOULOUSE (FR); Amandine AUDOUY, TOULOUSE (FR); Valentin DUPONT, TOULOUSE (FR)

(21) Appl. No.: 17/706,537

(22) Filed: Mar. 28, 2022

(30) Foreign Application Priority Data
Mar. 29, 2021 (FR) 2103186

(51) Int. Cl. G08G 5/00

(52) U.S. Cl. CPC G08G 5/0021; G08G 5/0039

(57) ABSTRACT

A device for assisting in the piloting of an aircraft, includes a competency module comprising a plurality of application components or capabilities, each capability having a competency domain and being configured according to one and the same logic format to calculate events based on data acquired from various certified or non-certified avionics sources and/or from various sources external or internal to the aircraft, and to process solution requests and generate solution proposals; a processing module comprising components that are configured to determine the presence of an impact on the current mission of the aircraft, either from a calculated event or from a solution proposal; a solution module comprising components that are configured to send solution requests based on the presence of an impact, and components that are configured to construct a solution for adapting the current mission of the aircraft based on at least one solution proposal; and a management module comprising components that are configured to manage conflicts and priorities of streams, and components that are configured to direct the exchanges between the various modules of the device.

### CROSS-REFERENCE TO RELATED APPLICATION

This application claims priority to foreign French patent application No. FR 2103186, filed on Mar. 29, 2021, the disclosure of which is incorporated by reference in its entirety.

### FIELD OF THE INVENTION

The technical field of the invention is that of aircraft mission management, and relates more particularly to a device for assisting in the piloting of aircraft.

### BACKGROUND

In aircraft of increasing complexity, the strategic management of an aircraft's mission, whether civil or military, involves an increasingly heavy workload on pilots, in particular when an event arises, whether internal to the aircraft (such as a system failure or a medical issue with a passenger) or external thereto (such as a change in the weather or damage to infrastructure), or else operational (for example, a change to the mission as originally planned).

The management of an aircraft and of its environment is currently based on three types of known avionics systems: Alert or “Flight Warning System” (FWS)-type systems, Management or “Flight Management System” (FMS)-type systems, and Monitoring-type systems.

Alert (FWS)-type systems are currently implemented in all types of aircraft. They serve a dual purpose: to alert the pilot when an abnormal situation arises and, where applicable, to present them with the procedures for dealing with the failure in order to bring the situation back under control, ensuring flight safety and the return of the aircraft to the ground.

In some, more elaborate systems, the FWS also proposes a list of inoperative systems (“INOP SYS”) and actions, to be dealt with later, to cover the repercussions of the failure on the rest of the mission (“DEFERRED PROCEDURE/LIMITATIONS”). In current aircraft, systems are increasingly interconnected, and the number of failures that may be generated by the system may be relatively large. In this case, it is the pilot who has to interpret and manage all of the information and the limitations which may be applicable to their situation.

Additionally, it should also be noted that in current FWSs, the information to be presented to the crew is determined statically by way of an analysis which is carried out during the design of the system and of the aircraft. This analysis is carried out while considering all of the aircraft's missions including worst-case scenarios, which is not necessarily the case of the current mission.

A number of flight management systems (FMSs) are also known, as above.

There are “Route Solver”-type devices, which aim to calculate a safe route with respect to the relief and the weather. This calculation does not take into account the state of the aircraft and its restrictions.

There are guiding devices which aim to calculate a route for guiding the aircraft. These devices guide the aircraft, potentially while checking the active path and triggering an alert for the crew or a reconfiguration when the situation deteriorates. This type of device only covers the current flight plan calculated by the device and no alternative flight plans.

There are devices for making the path safe which aim to make the path safe with respect to certain threats. In this case too, these devices generally do not take into account the state of the aircraft and its restrictions.

A number of Monitoring-type systems are also known, such as Traffic Collision Avoidance Systems (TCAS), Terrain Awareness and Warning Systems (TAWS), Weather Radar systems or International Space Station (ISS) systems. The aim of these systems is to trigger alerts if an aircraft is too close to a hazardous situation from the point of view of traffic, of terrain and of weather, respectively. They therefore address a tactical situation more than a strategic one and they notably do not allow an alternative flight plan/path to be considered.

With the various systems of the prior art, when there is a change in the state of the aircraft or an external event occurs, the pilot has to analyse the information provided and devise a strategy for adapting the mission which they consider to be optimal.

Most of the time, the pilot has to make do with analysing a subset of data that they consider to be relevant, as they have neither the time nor the capacity to reconsider the overall context, there being too much information. Thus, the pilot generally just assumes that the only changes with respect to the initial situation are those which triggered the analysis. However, this is not necessarily the case. For example, the weather at one of the possible alternate airports may have changed between flight preparation and the flight itself, thereby making the solution of diverting to this airport inoperable.

Lastly, among the means at their disposal, other than the alert or monitoring systems mentioned above, the pilot may consult the aircraft documentation of QRH (“Quick Reference Handbook”) type, either in paper format or digitalized as an EFB (“Electronic Flight Bag”), with a view to finding the main elements and information to be taken into account and to cross-check in order to analyse the situation.

Thus, the known assist systems aim to provide aid to the pilot to help them with analysing the impact of a change in context in a current mission.

The known approaches are primarily focused on presenting information to the crew. The patents U.S. Pat. No. 10,096,253 entitled “Methods and systems for presenting diversion destinations” and U.S. Pat. No. 10,109,203 entitled “Methods and systems for presenting en route diversion destinations”, propose such approaches. However, they do not provide proposals based on multiple criteria.

Moreover, the known assist solutions are instead based on defining a score which allows the pilot to see the status of various possible alternate airports, but they do not describe how to arrive at the solution.

Lastly, existing systems are either purely avionic systems subject to certification constraints on hardware and software, or “open-world” systems, also called non-avionic systems, i.e. non-certified systems (systems not subject to the same certification constraints as certified systems). Open-world systems cover hardware that may host software which is not certified but is subject to “OPS-Approval” by the operator. The open world has the advantage of having fewer constraints on development, with shorter development and deployment processes and, lastly, a possible connection to “cloud”-type servers which may share data via the Internet. In other words, with reference to the Arinc 811 standard, “avionics” is in the “CLOSED” category while, conversely, “Open World” is not in the “CLOSED” category.

Avionics systems primarily handle tactical and safety aspects of a change in context, i.e. they are oriented towards an immediate reaction that the pilot should have, and they do not analyse the medium-/long-term consequences. Even if these systems evolved to integrate suggestion capabilities, they would quickly find themselves limited in terms of computing power and also in terms of capabilities for collecting new data, in particular because their development and evolution cycles are lengthy, in particular due to certification constraints.

Open-world (and therefore non-certified) systems are not connected to the avionics. They therefore have a fragmentary view of a current situation because they do not continuously integrate the state of the aircraft and change in the envisaged mission.

Thus, to allow a pilot to take a decision, current systems do not take into account all of the data from the aircraft or from various services from the open world. The information that the pilot receives is then fragmentary and does not allow them to take a decision with an overall view of flight context and of environmental context.

Thus, there is a need for advanced assist systems and methods for aiding a pilot in analysing the impact of a change in context on the aircraft's current mission.

Such systems and methods should make it possible to correlate all of the information available and make it possible to provide a pilot, and a crew, with the best options in order to allow them to take a decision.

### SUMMARY OF THE INVENTION

One subject of the present invention is a device for assisting a crew, or “pilot assistant”, which comprises means that make it possible to analyse and then to correlate, in a reliable manner, all of the relevant information relating to an aircraft, and its environment, in order to determine whether a current situation has to be adapted and, if so, to propose solutions which appear to be most relevant for this adaptation.

Another subject of the invention is a method for assisting in piloting which comprises steps that make it possible to retrieve context data from various sources (i.e. the aircraft's avionics, ground data, open-world data); to construct a coherent overall context; to identify differences between this context and the initial context of the mission as envisaged; and to address these differences by proposing various alternatives, in order to allow the pilot to choose from among the proposed alternatives or to study other alternatives.

In general, the proposed solution takes the form of an assistant for the crew (one or more pilots), to:
assist in taking account of changes in the environment affecting a mission;
decrease the time spent on performing repetitive activities without much added value, by preparing and anticipating certain tasks;
decrease human error, by implementing reminders and contextualized assistance;
assist in meeting the expectations of passengers and operators.

Advantageously, the device of the invention is able to be adapted to any avionics without the principles and the concepts described and used in the suggestion mechanisms being affected.

To obtain the desired results, what is proposed is a device for assisting in the piloting of an aircraft, comprising:
a competency module comprising a plurality of application components or capabilities, each capability having a competency domain and being configured according to one and the same logic format to calculate events based on data acquired from various certified or non-certified avionics sources and/or from various sources external or internal to the aircraft, and to process solution requests and generate solution proposals;
a processing module comprising components that are configured to determine the presence of an impact on the current mission of the aircraft, either from a calculated event or from a solution proposal;
a solution module comprising components that are configured to send solution requests based on the presence of an impact, and components that are configured to construct a solution for adapting the current mission of the aircraft based on at least one solution proposal;
and
a management module comprising components that are configured to manage conflicts and priorities of streams, and components that are configured to direct the exchanges between the various modules of the device.

According to some alternative or combined embodiments:
The device additionally comprises a capability register and a capability database for recording and storing the competency domain of each capability.
The processing module comprises:
   a context component configured to either calculate a current context of the current mission for an event that is being analysed, or calculate a resulting context of the current mission for a solution proposal that is being analysed;
   a difference component configured to identify any difference between the initial context of the mission of the aircraft and the current context or the resulting context; and
   an impact component configured to determine, according to the one or more identified differences, an impact on the current mission from the analysed event or from the analysed solution proposal.
The components of the processing module are configured to perform an analysis according to an ontology.
The components of the processing module are configured to perform an analysis according to predefined rules.
The solution module additionally comprises a sorting module for evaluating and selecting solution proposals.
The sorting module is configured to evaluate and select solution proposals according to weighting criteria.
The competency module comprises at least one capability whose competency domain is that of managing the avionics systems, one capability whose competency domain is that of managing the mission of the aircraft, and one capability whose competency domain is that of managing the environment.
The device additionally comprises a human-machine interface configured to manage the interactions of one or more operators with the various modules of the device.

The invention additionally covers:
a certified avionics computing platform, comprising a device for assisting in the piloting of an aircraft according to the invention.
a non-certified avionics computing platform, comprising a device for assisting in the piloting of an aircraft according to the invention.
a computing platform comprising a device for assisting in the piloting of an aircraft according to the invention, in which the modules of the device for assisting in the piloting of an aircraft are distributed between the certified avionics, the non-certified avionics and ground infrastructure connected to the avionics via a data link.

### BRIEF DESCRIPTION OF THE DRAWINGS

Other features and advantages of the invention will become apparent with the aid of the following description and the figures of the appended drawings, in which:

FIG. 1 is a simplified illustration of the architecture of the device for assisting in piloting according to the invention;

FIG. 2 illustrates the structure of the application components of the competency module of the device for assisting in piloting of the invention;

FIG. 3 illustrates the elements of the device for assisting in piloting of the invention implemented to determine the presence of an impact on an aircraft's current mission;

FIG. 4 illustrates the elements of the device for assisting in piloting of the invention implemented to determine and generate a suggestion for adapting an aircraft's mission;

FIG. 5a, FIG. 5b and FIG. 5c illustrate variant implementations of the device for assisting in piloting of the invention.

### DETAILED DESCRIPTION

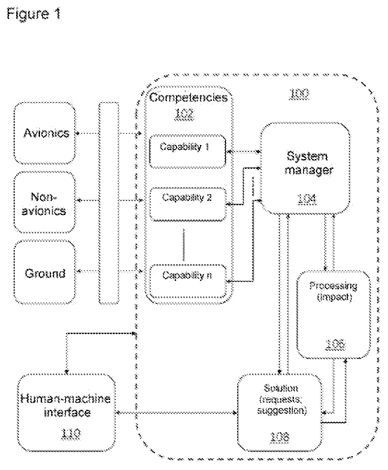

FIG. 1 illustrates an exemplary architecture of a system for assisting in piloting according to the invention. The device (100) for assisting in the piloting of an aircraft of the invention generally comprises at least one competency module (102), a management module (104), a processing module (106) and a solution module (108).

The management module (104) is configured to manage conflicts and priorities of streams passing between various modules and to direct the exchanges between the various modules of the device.

The device for assisting in piloting of the invention additionally comprises a human-machine interface HMI (110) configured to manage the various human-machine interactions in the context of using the device for assisting in piloting of the invention.

The HMI is configured (i.e. comprises various interfaces adapted to the type of interaction) to allow one or more operators to interact with various modules of the assisting device or “Assistant”, and with various services and/or components of the avionics and/or from the open world, on board and/or on the ground.

The interactions and information that are exchanged take place via various interface configurations which are, at least:

an “Operator (pilot)/Assistant”-configured interface for soliciting the Assistant in various ways (multimodality):natural language, touch, “Eye tracking”, sound/acoustic alarm, microgesture, but also through computer requests (notifications).

an “MRO” (“Maintenance Repair & Overhaul”)-configured interface for interacting with a maintenance, repair and overhaul service:

In the MRO→Assistant direction:
Exchange of maintenance capabilities per airport.
“Spare” available per centre.

In the Assistant→MRO direction:
Sending detected failures.

an “ATC” (“Air Traffic Control”)-configured interface for interacting with air traffic control:

In the ATC→Assistant direction, sending:
“D-NOTAM” (“Digital Notice To AirMen”) or digital-format information which is a message published by government agencies for air navigation control for the purpose of informing pilots of events (changes, closures, failures, work, forbidden areas, etc.) in infrastructure. When preparing to fly, the pilot has to consult them in order to check the safety of their mission.
ATC instructions.
“D-ATIS” (“Digital Automatic Terminal Information Service”) which is an automatic broadcast service allowing pilots to continuously receive (new recording generally every half hour) information on the most used airports. These messages may in particular contain weather data, runways in service, available approaches, etc.

in the Assistant→ATC direction, sending:
Signalling hazardous weather situations (windshear, turbulence, freezing conditions).

an “Environment”-configured interface for interacting with weather services able to provide environmental data:

In the Ground→Assistant direction, sending:
Weather (“wind”, “windshear”, temperature, convections, “icing”, “ASHTAM” which is a special NOTAM for describing the status of the activity of a volcano when this might affect flight progress/safety, “SNOWTAM” which is a special NOTAM relating to snowed-up conditions on an airport's runways, etc.).
“Weather uplink” (en route), which is a message transmitted via the Datalink (ground/plane link) containing weather information (winds, temperatures) on the points of the planned path.
“METAR” for “METeorogical Aerodrome Report” which is a report on the weather conditions as observed from the ground at an airfield,
“TAF” for “Terminal Aerodrome Forecast” which is a weather forecast valid for 6 to 30 h for an airfield, using similar coding to the METAR format, at airports.
Weather conditions at the arrival airport and possibles alternate airports.
States of planned and possible landing runways (contamination level, presence of rain, snow, etc.).
Traffic around the aircraft (air+ground).

a “Mission”-configured interface for interacting with systems able to provide data relating to the aircraft's mission:

In the avionics→Assistant direction, sending:
Active flight plan
Required operational capabilities to carry out the mission (takeoff type, approach type, etc.).
Remaining flight time.
Fuel on board
Weight
Changes to the flight plan from the avionics
Current position of the aeroplane

In the Assistant→avionics direction, sending:
Flight plan suggested by the Assistant and chosen by the pilot
Performance factor (“Perf Factor”)
Performance loss factor (thrust loss, aerodynamic drag, braking distance).

a “systems”-configured interface for interacting with systems able to provide data relating to the state of the aircraft's systems:

In the avionics→Assistant direction, sending:
List of inoperative systems.
Alerts detected.
Pilot actions on the “FWS” (“Flight Warning System”) procedures.
States/position of certain systems (position of slats and flaps, “anti-ice” active or inactive).

In the Open-world application→Assistant direction, sending:
Limitations/restrictions identified in the “e-Logbook”.
“MEL”.

In the Assistant→Open-world application direction:
Failures detected for the e-Logbook.

In the Assistant→avionics direction:
Flight envelope restriction (speed, altitude)
Actions on the controls and associated timing (activation of de-icing, etc.).

The data required by the device of the invention are:

airport database (airport position, runway characteristics, takeoff and landing procedures, classification in terms of difficulty (due to terrain, to traffic)).

Database containing safety altitudes.

Infrastructure associated with the airport (hotel, repair centre, transport means)

Geopolitical map and associated constraints (visa).

Database containing inoperative systems <-> operational limitations associations.

Landing/takeoff performance database.

Consumption database.

The data exchanged with the ground for the requirements of the device of the invention are:

Suggestions made

Pilot choice

Associated contexts

Pilot requests

Pilot modifications made based on suggestions

Difference between suggestions and flight made/flight data

Internal algorithmic data (for example, suggestions made on a version N+1 of the Assistant “ghost mode”).

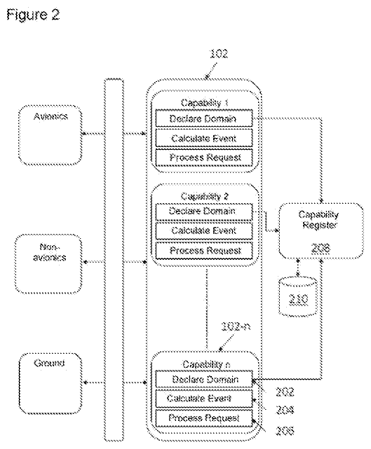

The competency module (102) comprises a plurality ‘n’ of application components, also referred to as capabilities (capability₁, . . . capabilityᵢ, . . . , capabilityₙ). Each capability is configured according to one and the same logic format in order to perform at least three types of functions, illustrated in FIG. 2, namely:
declaring a competency domain (202);
calculating events (204);
processing solution requests and generating solution proposals (206).

The competency module (102) comprises at least an “Avionics systems management” capability, a “Mission management” capability, and an “Environment management” capability.

The general function of the “Avionics systems management” capability is to know the aircraft's status, and thus:
to collect the state of aircraft systems from the avionics portion.
to determine the operational limitations according to the state (actual or imposed by the pilot after a “what if” simulation) of the avionics systems. A “what-if” test is a simulation of what would happen if an event took place.
to check the compatibility between a change in situation (for example: a change in flight plan requested by the pilot/caused by a change in environmental context) and the state (actual or imposed by the pilot) of the machine.
to transmit instructions/objectives to the systems of the aircraft (change in the state of a system, action on the system).
to monitor the correct execution of the instruction/the achievement of objectives.

In one implementation, the architecture of the “Avionics systems management” capability is based on multiple functional components which are a “System Management Driver”, a “System Management Service” and a “System Management Skill”.

The “System Management Driver” is configured to perform the role/function of abstracting the architecture with respect to the utilities of the systems in order to “trivialize” the link between an inoperative system and the resulting limitations. Specifically, FCOM (“Flight Crew Operating Manual”) analyses carried out on various carriers show that the operational limitations are more or less of the same type regardless of the carrier. However, since the architecture of the systems differs from one carrier to the next, the limitations may be triggered by different root causes (for example, a single or double failure). Additionally, the components of the systems rarely have the same designations from one carrier to the next. Thus, advantageously, the “System Management Driver” module makes it possible to overcome this issue by absorbing the associated variability. To do this, each inoperative system is associated with a failure family and a trivialized limitation family, per configuration file.

One non-limiting example is given for the engine failure family “Family=Engine”, for which an associated root cause may be “Fault=Engine 1 System” and resulting limitation may be “Delay Take Off”, where the parameters are no longer associated with a specific aircraft, and become generic parameters.

This “trivialization” component thus makes it possible to acquire all of the required data while overcoming the constraints inherent to the carrier (data name, source selection logics). This is the case, for example, for data such as aeroplane mass, heading, radio frequencies, fuel flow, etc.

The “System management Service” is configured to perform multiple roles/functions, which are:
storing the state of the various systems and data received from the avionics and various other data. This state may either be received directly from a FWS (i.e. a list of inoperative systems) or be deduced from pilot actions on the procedures (i.e. a system may, for example, be operating correctly but be turned off to reduce electricity consumption, which may cause limitations). This storage is made necessary by the fact that the received information may reflect not the state of the aircraft but the modifications made thereto and change with time (for example, the fuel on board which may be used in addition to the failure information to evaluate the extent/change in a fuel leak. In a normal situation, this information makes it possible, for example, to determine that the pilot has selected a particular command which is not directly found in the system state data (de-icing activated for example).
consolidating and calculating the impact of the limitations. Based on the list of inoperative systems, it establishes a list of limitations (for example, if two faulty systems produce a limitation on the same capability—runway length for example—it produces an overall result). To do this, this component incorporates a configurable mechanism for calculating logics/values which makes it possible to define the processing to be applied to limitations of the same nature. One possible solution is that provided by the “Detection” component of the FWS.
Depending on the case, for example, speed limitations may build up or else it may be necessary just to take the most disadvantageous.

Thus, the following services are identified, for example (non-exhaustive list):
Performance factor. This factor makes it possible to say, according to the detected failure, by how much the aircraft will consume in excess with respect to normal.
Required runway length: This information makes it possible to determine the length required for the aircraft to land according to its state, its mass and the weather conditions.
Approach minima: This information makes it possible to say, depending on the state of the aircraft, which minima are attainable.
Flight envelope reduction: This information makes it possible to identify whether, depending on its state, the aircraft is limited in terms of altitude, speed, roll and takeoff/landing configuration.

The “System management Skill” has the following roles/functions:
consolidating the state of the aircraft: Based on the information produced by the “System Management Service”, and once it has determined that the aircraft is in a stabilized state, it generates a notification to inform of modifications made/undergone by the aircraft.
checking, based on information on the state of the systems, whether a change in context is compatible from the point of view of the state of the aircraft (“Check System State Compliance”), such as, for example, a change in the flight plan to go from a CAT3a landing to an LPV procedure: can the aircraft perform LPV?
This mechanism is necessary to ensure that limitations that had no impact or had a different impact when they occurred are taken into account retroactively. For example, the loss of the LPV capability is without impact if this capability is not envisaged in the initial mission but makes changing the flight plan impossible if it is required in the intended change.
querying the capability to evaluate the impact of an imaginary loss imposed by the pilot on the state of the machine (“Simulate What If”).

The “Environment management” component has the following function:
collecting, capturing, consolidating and storing the environmental situation and the environmental data via the ground/plane connectivity:
   from ATC: D-NOTAM (states of the guidance and communication means, Flight restrictions), ATC, D-ATIS (states of runways, airport services) instructions, traffic around the aircraft;
   from weather services: Weather (wind, windshear, temperature, convections, icing, ASHTAM, SNOWTAM, etc.), weather “en route”, METAR, TAF and states of runways at the destination and possible alternate airports.
checking the compatibility between a change in situation (for example: a change in flight plan requested by the pilot/caused by a change in the state of the machine) and the environmental context (windshear, NOTAMs, etc.)

The “Mission management” capability is linked to the applications providing the weather data relating to the flight and thus has the following function:
collecting the mission data from the avionics portion.
checking the compatibility between a change in situation (for example: a change in flight plan requested by the pilot/caused by a change in environmental or aircraft context) and the characteristics of the mission (destination, amount of fuel, flight profile).
determining modifications to the mission that are likely to be compatible with the environment and the state of the aircraft (actual or imposed by the pilot: “what if”). transferring the mission modifications selected by the crew to the avionics portion.

In one implementation, the architecture of the “Mission management” capability is based on multiple functional components which are an “FMS Driver”, a “Leg Services”, and a “Mission Skill”.

The role of the “FMS Driver” is to abstract the mission management system (for example an FMS) from the aircraft, and it makes it possible:
to retrieve information on the current mission such as, for example, the flight plan of the current mission, the approach type and the amount of fuel on board the aircraft.
to transfer flight plan modifications arising from the proposed suggestions. To do this, it converts the received solution requests to the protocol format expected by the FMS present on board.

The “Leg Services” has the role of:
storing the current flight plan and broadcasting the information. By virtue of this, it allows the various capabilities and services to access the flight plan data by managing concurrent accesses to the information.
promoting and transmitting mission modifications arising from the suggestions to the avionics. To do this, the component interfaces with the “FMS Driver”.

The “Mission Skill” has the role of:
producing a notification once the state of the mission is stabilized.

ensuring the conformity of the mission (“Check Mission Compliance”) with a change in context due to the environment (for example, a diversion to avoid a poor weather situation) or the state of the machine (for example, excess consumption). To ensure conformity, a simple comparison is made between what is envisaged and the current context increased by a margin. Thus, access to the following mission data is necessary:

Remaining flight time (in case of fuel leak, depressurization, for example)
Amount of fuel, amount expected on arrival (fuel leak)
Expected approach and takeoff category (ILS, GLS, LPV, RNP AR, etc.)
Expected runway and associated length
Cruising altitude (flight envelope limitation)
Max horizontal and vertical speed (flight envelope limitation).

evaluating and proposing a solution in the event of context change (“Compute Mission Update”). Unsecured elements (ground infrastructure for example) are used as sorting criteria between various suggestions. The following services are identified as being necessary:
Adding additional time: makes it possible to evaluate the feasibility (arrival within the time, weather risk) and the cost caused (excess consumption) by a delay.
Defining an alternate airport according to:
   The maximum flight duration (in case of fuel leak, depressurization, for example).
   The amount of fuel (leak)
   Available approach categories (limitation preventing an ILS, GLS, LPV, RNP AR, etc. approach)
   The required landing distance (limitations on the braking system).
Defining a lateral avoidance according to:
   The weather
   The fuel on board
   The target time of arrival
   The definition of a flight plan modification (vertical or horizontal) according to flight envelope restrictions (speed, altitude).

According to some variant embodiments, the competency module may comprise other capabilities, such as, for example, non-limitingly:
an “ATC” capability charged with (i.e. its competency domain, its function) decoding “datalink ATC” messages;
a multimodality capability translating ATC instructions—voice;
a capability whose competency domain (its function) is retrieving maintenance information;
a capability whose competency domain (its function) is capturing pilot selections and tracking them over time by monitoring the associated parameters.

Returning to FIG. 2, advantageously, the device of the invention allows, via a capability register (208) coupled to a capability database (210), the addition and/or the removal of application components to and/or from the competency module (102). Each component, once recorded according to its competency domain, may organize the requests to the various respective services and systems (avionics; non-avionics; ground) allowing the functions of event calculation (204) and request processing (206) to be performed.

The competency domain of a capability is declared in the capability register (208) and recorded in the capability database (210) in order to indicate the functional domain of the application component, the nature of the data relating to this functional domain, the type/format of data of which the capability will have need to exercise the functions of calculating events (204) and of processing requests (206), and the type/format of data that the capability will produce.

The “event calculation” (204) function of an application component is responsible for consolidating the information received before sending and requesting an event with respect to the Assistant. It is configured to prevent mass requests and ensure that the most relevant notifications are sent. Specifically, it is necessary to ensure that the context leading to the notification corresponds to a stable state. For example, an engine failure will result in the loss of multiple systems. This loss is not simultaneous. It is therefore necessary to wait for the situation to stabilize before notifying. If this is not done, the risk is that non-relevant calculations and suggestions will be given to the pilot due to taking into account only part of the situation which is not yet stable.

For the “Avionics systems management” component, the event calculation function essentially consists in calculating operational limitations of the aircraft.

For the “Mission management” component, the event calculation function essentially consists in generating mission data.

For the “Environment management” component, the event calculation function essentially consists in calculating weather events.

The “Request processing” (206) function of an application component consists in receiving, via the management module (104), solution requests sent by the solution module (108), and then in handling these requests by calling upon the appropriate services and systems for retrieving data, and sending a response back to the solution module via the management module.

For the “Avionics systems management” component, the request processing function consists essentially in checking the state of the systems and performing a “what if” simulation (for example, what would the impacts on the aeroplane be if this or that avionics system failed? : “I've lost system 1, I have a suggestion for an alternate route which depends on the use of system 2, what would happen if system 2 were lost? If I have another, more robust alternative in case system 2 is lost, it might be worth favouring that one”).

For the “Mission management” component, the request processing function consists essentially in checking the conformity of the mission, in calculating a mission update and in promoting the flight plan, i.e. providing the flight plan to the avionics systems (FMS in particular) for acceptance.

Checking the conformity of the mission consists essentially in checking that all of the minimum information required for carrying out a mission (e.g. aeroplane type, departure and arrival airport, mass and fuel data, etc.) is available and that the mission is achievable from the point of view of the environment and the state of the aircraft, i.e. the aircraft will not land at an airport with strong winds on arrival if the aircraft is not capable thereof, or reroute to an airport that cannot be reached due to insufficient fuel or due to too high an altitude considering performance.

For the “Environment management” component, the request processing function consists essentially in checking the conformity of the weather, i.e. checking that the weather is compatible with the mission (the mission is achievable under the weather conditions expected on its path and at the airports).

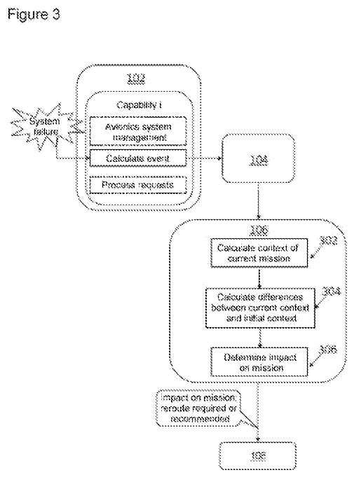

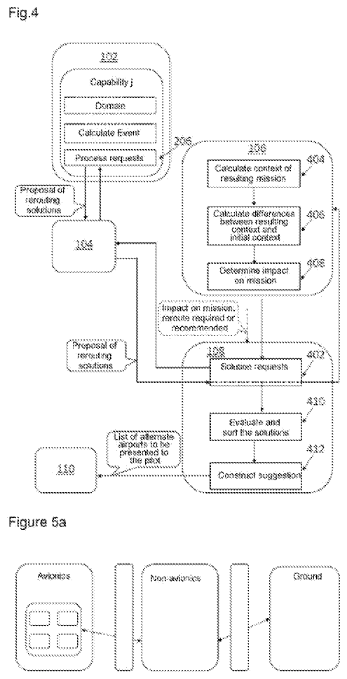

Returning to FIG. 1, as indicated, the device of the invention comprises a processing module (106). The processing module is configured, on the one hand, to determine what the potential impacts on the current mission are from events calculated by the application components (illustrated in FIG. 3) and, on the other hand, to carry out checks on the relevance of solutions generated by the application components for adapting the current mission (illustrated in FIG. 4).

FIG. 3 illustrates the configuration of the components of the processing module (106) implemented when processing an event, in order to determine whether or not the event has an impact on the mission.

For the sake of simplifying the description and of clarity, one example is taken to describe the processing of an event, which corresponds to the failure of a system, by the “Systems management” capability. A person skilled in the art will generalize the described mechanisms to other events and to other application components. Thus, another example is that of an event calculated by the “Environment management” capability corresponding to a change in weather (the processing of this event leading to an area avoidance proposal).

The processing module receives as input the data routed by the management module (104). The management module transmits the information calculated or sent by the various competency modules, either when calculating an event (for example, the updated wind speed values in the case of a weather event notification by the “Environment management” capability), or when processing a solution request (for example, the impacts on the aircraft's capabilities in the event of a failure). The information delivered to the management module is calculated based on data acquired from various certified and/or non-certified avionics sources and/or from various sources external and/or internal to the aircraft. The data are put in a format that can be used by open-world (non-avionics) systems.

As illustrated in FIG. 3, the “Systems management” capability calculates an event based on information on the state of the aircraft systems collected from the avionics portion and, in this example, chosen so as to return a “system failure”.

In general, the processing module (106) comprises:
a context component (302) configured to calculate an overall current context of the current mission on an event which is being analysed;
a difference component (304) configured to identify any deviation/any difference between the overall current context provided by the context calculation component (302) and the initial context of the aircraft's mission; and
an impact component (310) configured to determine what the impact of the event on the mission is according to the one or more differences identified by the difference identification component (304).

In one embodiment, the processing operations performed by the processing module (106) are based on an analysis according to an ontology.

In one embodiment, the processing operations performed by the processing module (106) are based on an analysis according to predefined rules.

In the chosen example, the impact that is determined consists in rerouting of the aircraft being required or recommended.

FIG. 4 illustrates the elements implemented to determine a suggestion for adapting a mission. In particular, FIG. 4 illustrates the components of the solution module (108) and the configuration of the components of the processing module (106) for checking the relevance of solution proposals for adapting the current mission.

In general, the solution module (108) comprises:
a solution request component (402) configured to construct and send solution requests for querying application components according to their competency domain and according to the calculated impact;
a sorting component (410) configured to sort solution proposals; and
a suggestion component (412) configured to construct a solution for adapting the aircraft's current mission according to the evaluation of the solution proposals.

Based on the information on the impact on the current mission, for example a required reroute, the solution request component (402) generates corresponding requests.

The requests are routed to the capabilities that are to process them via the management module (104) based on the information available in the capability register (208).

Thus, in the chosen example, requests are established for querying at least the “Mission management” capability so as to obtain proposals for rerouting to the airports able to propose it. A person skilled in the art understands that the example is simplified but that solution requests of greater or lesser complexity may be addressed to one or more capabilities according to the nature of the calculated impact.

The requests are processed by the respective capabilities based on data acquired from various certified or non-certified avionics sources and/or from various sources external or internal to the aircraft.

The received impact solution proposals are evaluated via the processing module (106). The evaluation of a proposal successively implements the functionalities of the context component (404) by calculating a resulting context for the mission if the solution of the proposal were implemented, of the difference component (406) for the difference between the resulting context and the initial context, and of the impact component (408) by determining what the impact on the mission would be if the solution of the proposal were implemented.

In one embodiment, the processing operations performed by the processing module (106) are based on an analysis according to an ontology.

In one embodiment, the processing operations performed by the processing module (106) are based on an analysis according to predefined rules.

Advantageously, the solution request component (402) may generate new requests according to the calculated impact, and receive new solution proposals which are evaluated by the processing module (106).

The sorting component (410) is configured to weight the solutions found according to sorting criteria adapted to the situation and to the crew issues.

Advantageously, by recording the pilot choices that have been made and the associated context, the weighting criteria may be adapted a posteriori so as to fit the situation ever better over time. In addition, by capturing the alternatives actually selected/executed, it makes it possible to enrich the knowledge of the device in post-analysis.

The suggestion component (412) is configured to structure the retained suggestions so as to be able to notify the crew and present (110) the elements to them with associated rationale.

In one embodiment, to prevent errors, at least three suggestions are proposed to the crew. Advantageously, the recording of this information allows the search for a solution to be enriched which becomes increasingly effective over time.

Once the chosen alternative has been validated, the device of the invention allows the elements of this alternative to be transferred to the avionics side, or the ground side, so that it becomes the new mission reference.

The device allows the execution of the new reference to be monitored in order to detect differences.

Advantageously, the device allows the use of various services to be contextualized according to the policies of airlines and system users (pilots).

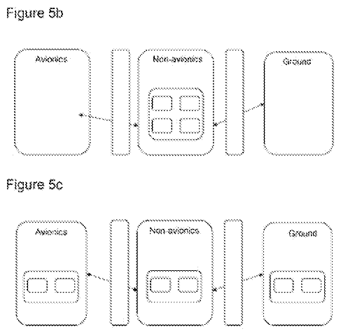

FIG. 5a illustrates one exemplary implementation of the device for assisting in piloting of the invention in which all of the modules are integrated into a certified avionics computing platform.

FIG. 5b illustrates another exemplary implementation of the device for assisting in piloting of the invention in which all of the modules are integrated into a non-certified avionics computing platform.

FIG. 5c illustrates another exemplary implementation of the device for assisting in piloting of the invention in which the modules are distributed between certified avionics computing platforms, non-certified avionics computing platforms and ground infrastructure computing platforms. In this implementation, the processing and solution components are implemented on a non-certified avionics computing platform. The ground infrastructure platform is connected to the avionics platform via a data link.

1. A device for assisting in the piloting of an aircraft, comprising:
a competency module configured to record, according to one and the same logic format, application components called capabilities, each capability having a competency domain characterizing its functional domain, the nature and the format of the data relating to this functional domain, and being configured to perform, in its competency domain, at least the following functions:
calculating events based on data relating to said functional domain which are acquired from various certified or non-certified avionics sources and/or from various sources external or internal to the aircraft;
processing requests to solve events affecting the current mission of an aircraft, said events being calculated by said capability and/or by other capabilities, said requests being processed based on data relating to said functional domain of said capability which are acquired from various certified or non-certified avionics sources and/or from various sources external or internal to the aircraft;
generating event solution proposals;
a processing module comprising components that are configured to determine the presence of an impact on the current mission of the aircraft, either for an event calculated by a capability or for an event solution proposal generated by a capability;
a solution module comprising components configured to:
send solution requests to one or more capabilities of the competency module;
evaluate event solution proposals;
construct solutions for adapting the current mission of the aircraft based on at least one event solution proposal;
and
a management module comprising components that are configured to manage conflicts and priorities of streams, and components that are configured to direct the exchanges between the various modules of the device.

2. The device according to claim 1, additionally comprising a capability register and a capability database for recording and storing the competency domain of each capability.

3. The device according to claim 1, wherein the processing module comprises:
a context component configured to calculate either a current context of the current mission of the aircraft for an analysed event, or a resulting context of the current mission of the aircraft for an analysed event solution proposal;
a difference component configured to identify any difference between the initial context of the mission of the aircraft and the current context or the resulting context which is calculated; and
an impact component configured to determine, according to the one or more identified differences, the presence of an impact on the current mission of the aircraft.

4. The device according to claim 1, wherein the components of the processing module are configured to perform an analysis according to an ontology.

5. The device according to claim 1, wherein the components of the processing module are configured to perform an analysis according to predefined rules.

6. The device according to claim 1, wherein the solution module additionally comprises a sorting module for selecting solution proposals.

7. The device according to claim 6, wherein the sorting module is configured to select solution proposals according to weighting criteria.

8. The device according to claim 1, wherein the competency module comprises at least one capability whose competency domain is that of managing the avionics systems, one capability whose competency domain is that of managing the mission of the aircraft, and one capability whose competency domain is that of managing the environment.

9. The device according to claim 1, additionally comprising a human-machine interface configured to manage the interactions of one or more operators with the various modules of the device.

10. A certified avionics computing platform, comprising a device for assisting in the piloting of an aircraft according to claim 1.

11. A non-certified avionics computing platform, comprising a device for assisting in the piloting of an aircraft according to claim 1.

12. The computing platform comprising a device for assisting in the piloting of an aircraft according to claim 1, wherein the modules of the device for assisting in the piloting of an aircraft are distributed between the certified avionics, the non-certified avionics and ground infrastructure connected to the avionics via a data link.
